(19) United States
(12) Patent Application Publication
(10) Pub. No.: US 2016/0170581 A1
(43) Pub. Date: Jun. 16, 2016

(54) INTERFACE DISPLAY METHOD FOR APPLICATION PRODUCT PLATFORM AND INTELLIGENT TERMINAL EQUIPMENT

(71) Applicant: SHENZHEN SKYWORTH-RGB ELECTRONIC CO., LTD., Guangdong (CN)

(72) Inventors: ZHIGUO WANG, Shenzhen (CN); XIANHUI ZENG, Shenzhen (CN); WEILONG LV, Shenzhen (CN); YAN YANG, Shenzhen (CN); JING CHENG, Shenzhen (CN)

(73) Assignee: SHENZHEN SKYWORTH-RGB ELECTRONIC CO., LTD., Shenzhen (CN)

(21) Appl. No.: 14/907,761

(22) PCT Filed: Oct. 21, 2013
(86) PCT No.: PCT/CN2013/085535

§ 371 Date: Jan. 26, 2016

(30) Foreign Application Priority Data
Jul. 30, 2013 (CN) 201310324650.7

(51) Int. Cl. G06F 3/0482

(52) U.S. Cl. CPC G06F 3/0482

(57) ABSTRACT

The present invention discloses an interface display method of application product platform and intelligent terminal equipment. The method comprises the following steps: acquiring starting instructions of the application product platform, opening a display window comprising category labels and a view currently corresponding to the category labels, and placing a focus on one item in the view; acquiring item switching instructions of a first set of input mechanism from remote control equipment, and focus is moved from current item to next; acquiring category-switching instructions of a second set of input mechanism, switching the current view to next. Due to both category-labels switching and items browsing are controlled by independent keys, and focus locates on no labels, moves in item lists in views only, thus the required operation steps for cross categories browsing are saved, and operational process is simplified.

### FIELD OF THE INVENTION

The present invention relates to the field of intelligent terminal equipment technology, and more particularly, to an interface display method of application product platform and intelligent terminal equipment.

### BACKGROUND

Following the rapid development of mobile computer technologies and software systems, more and more various applications are available on an intelligent platform, which gradually become an integral part of a personalized user's equipment. These days, almost all major smart devices have application product platforms integrated, such as an applications store, applied for applications downloading and installing. The same happened to a smart TV.

For intelligent terminal equipments having display screens, and requiring a remote control device as an operation medium, such as a television, users can not finish a variety of operations with intuitive actions, such as dragging and clicking, the same as operating a device with touching screens. Therefore, the interface display of application product platform in a TV has its unique specializations. Currently, an interface display method of application product platform designed for the class of TV products may refer to FIG. 1, taking the applications store for an example, generally, the display processes are as follows:

1. start and enter the applications store, open a display window on the display screen, the display window includes category labels (such as “All”, “Games”, etc.) and the corresponding views, and, at this time, the focus locates on an All label, and the system starts loading items contained in the label.

2. when all items in the All label are loaded completely, the user may move the focus to one item in the view, by using arrow keys (up, down, left, right) in the remote control device, for example, move the focus to an application 4 as shown in FIG. 1;

If the user wants to browse applications listed in the “Entertainments” label, he need first move the focus back to the “All” label, then press the right arrow key to switch the focus to the “Games” label, and wait for items in the game page finished loading, then he need press the right arrow key again, and switch the focus to the “Education” label, and so on, until the focus is switched to the “Entertainments” label, before he can browse the application items in the view with arrow keys.

From the above described processes, we can see that, at current technologies, the interface display of application product platform relies on the focus moving by using a remote control device, before carrying out items browsing and different category views switching functions. A user must first move the focus back to the category label before any cross-categories browsing.

### BRIEF SUMMARY OF THE DISCLOSURE

According to one aspect of the present invention, it provides an interface display method of application product platform, including the following steps: acquiring a starting instruction for the application product platform, opening a display window on a display screen according to the starting instruction, wherein, the display window includes a category label and a corresponding view to the current category label, and there is at least one item listed in the view, and a focus locating on one item in the view; acquiring an item-switching instruction, which is corresponding to a signal from a first set of input mechanism in a remote control device, and moving the focus to a next item from a current item, based on the item-switching instruction; acquiring a category-switching instruction, which is corresponding to a signal from a second set of input mechanism in the remote control device, and switching the current view to the next one, while locating the focus onto one item in the new view, based on the category-switching instruction, wherein, the second set of input mechanism is totally different to the first set of input mechanism.

According to another aspect of the present invention, it provides intelligent terminal equipment, for example, it may be a smart TV, a smart TV box or a video displaying box, which may connect to and control a TV screen display. The intelligent terminal equipment includes: a display unit, applied to control the screen displays; a remote control signals receiving unit, applied to receive signals from the remote control device; a storage unit, applied to store data, including a program capable of being executed by a processor; a processor, data connecting to the display unit, the remote control signals receiving unit and the storage unit, applied to execute the programs, which includes achieving the aforementioned interface display method of application product platform.

When the intelligent terminal equipment described in the present invention is displaying interface of application product platform, category labels switching and item labels browsing are controlled by relatively independent key signals, and labels are no more catching focuses, while the focus moves only in various item lists in the views, which significantly saves the operation steps required when browsing across different categories, and simplifies the operation processes, thus gives users a better operation experience.

More detailed descriptions on the specific embodiments of the present invention are described below, together with the accompany drawings.

### BRIEF DESCRIPTION OF THE DRAWINGS

FIG. 1 illustrates a schematic diagram on the conventional interface display method of application product platform;

FIG. 2 illustrates a schematic block diagram of intelligent terminal equipment as described in one embodiment of the present invention;

FIG. 3 illustrates a flow chart of an interface display method of application product platform as described in one embodiment of the present invention;

FIG. 4 illustrates a schematic diagram showing a display window locating in the “Application management” category, as described in an embodiment of the present invention;

FIG. 5 illustrates a schematic diagram showing a display window locating in the “Latest recommend” category, as described in an embodiment of the present invention;

FIG. 6 illustrates a schematic diagram showing a display window locating in the “Search” category, as described in an embodiment of the present invention;

FIG. 7 illustrates a schematic diagram of a remote control device according to an embodiment of the present invention;

FIG. 8 illustrates a schematic diagram showing an item window locating at the “Details” subcategory, as described in an embodiment of the present invention (for applications not downloaded);

FIG. 9 illustrates a schematic diagram showing an item window locating at the “Details” subcategory, as described in an embodiment of the present invention (for applications already installed);

FIG. 10 illustrates a schematic diagram showing an item window locating at the “Screenshots” subcategory, as described in an embodiment of the present invention.

### DETAILED DESCRIPTION

The present invention provides an interface display method of application product platform and intelligent terminal equipment, in order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

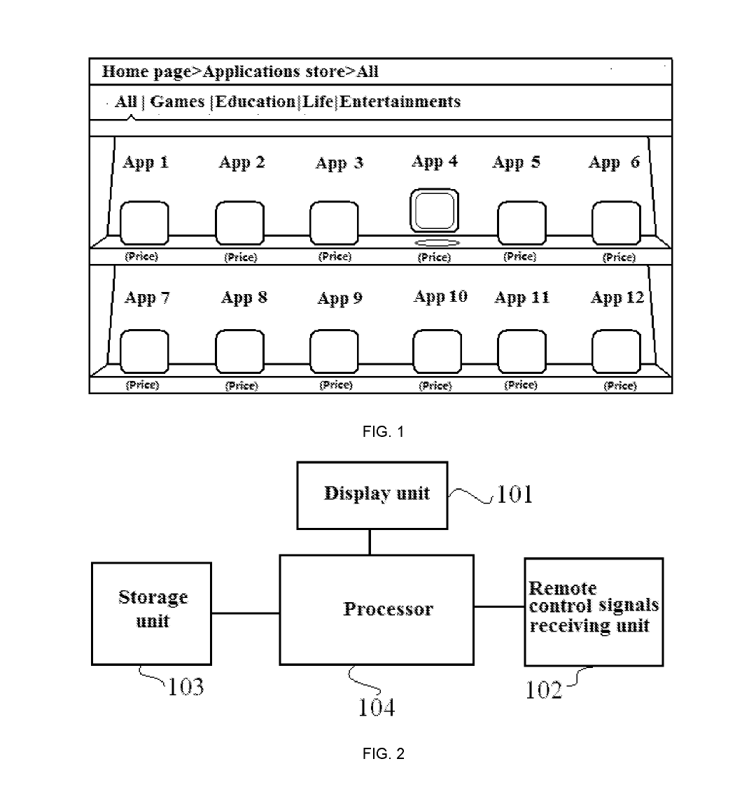

A schematic block diagram of intelligent terminal equipment as described in one embodiment of the present invention may refer to FIG. 2, it includes:

a display unit 101, applied to control a screen display;

a remote control signals receiving unit 102, applied to receive a signal from a remote control device;

a storage unit 103, applied to store data, including a program capable of being executed by a processor;

a processor 104, data connecting to the display unit 101, the remote control signals receiving unit 102 and the storage unit 103, applied to execute the programs, which include achieving an interface display method of application product platform according to the present invention, for example, an interface display method of application product platform as described below.

The intelligent terminal equipment, for example, may be a smart TV, may also be a smart TV box, a video displaying box, or else, which connects to and controls the screen displays of a TV or other display devices. Based on different types of equipments, the above said functional units may be achieved in different ways, corresponding to their conventional hardware realization forms. For example, the display unit 101 may be a specialized chip for video signals decoding, or a software programmed combining processor processed functional module; the remote control signals receiving unit 102 may be a wireless signals receiver, receiving wireless signals including infrared signals, Bluetooth signals and more; the storage unit 103 may be a built-in high-speed cache or a memory card, etc., it may also be an external removable memory card or a flash drive, etc., there are no limitations on it in the present embodiment.

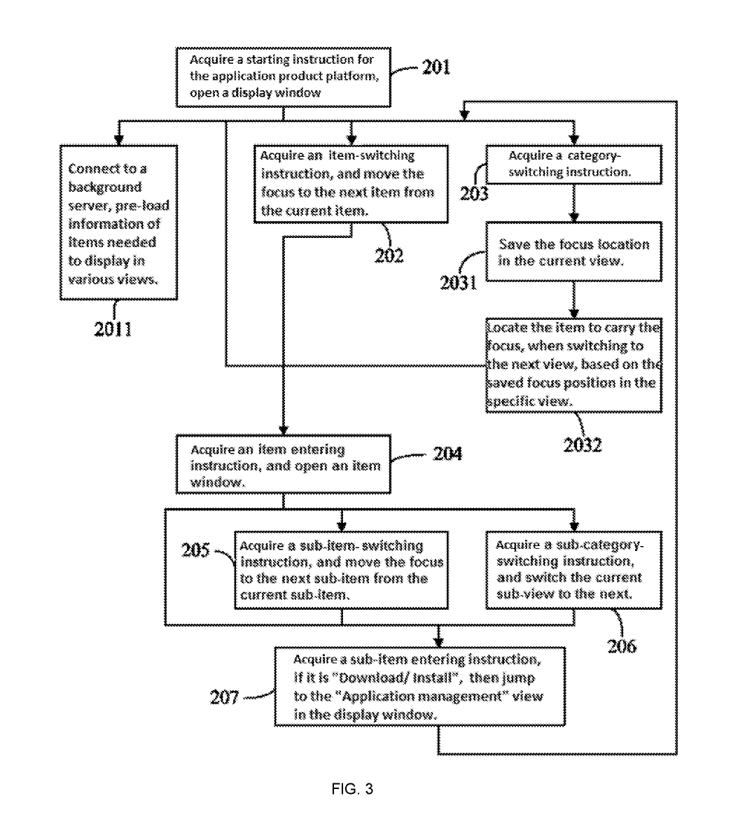

An interface display method of application product platform as described in one embodiment of the present invention may refer to FIG. 3, it includes the following steps: 201. acquire a starting instruction for the application product platform, and opening a display window.

The application product platform may be launched in a conventional way, for example, one may enter an application product platform through a parent directory containing the specific application product platform, in details, when the focus is moved to the specific application product platform from the parent directory, signals corresponding to the “OK” key in the remote control device are applied as the starting instruction. Of course, a specific key may also be arranged in the remote control device, and signals corresponding to these specific keys are applied to be the starting instruction. After the starting instruction is received, display windows may be launched in the display screen, according to the starting instruction.

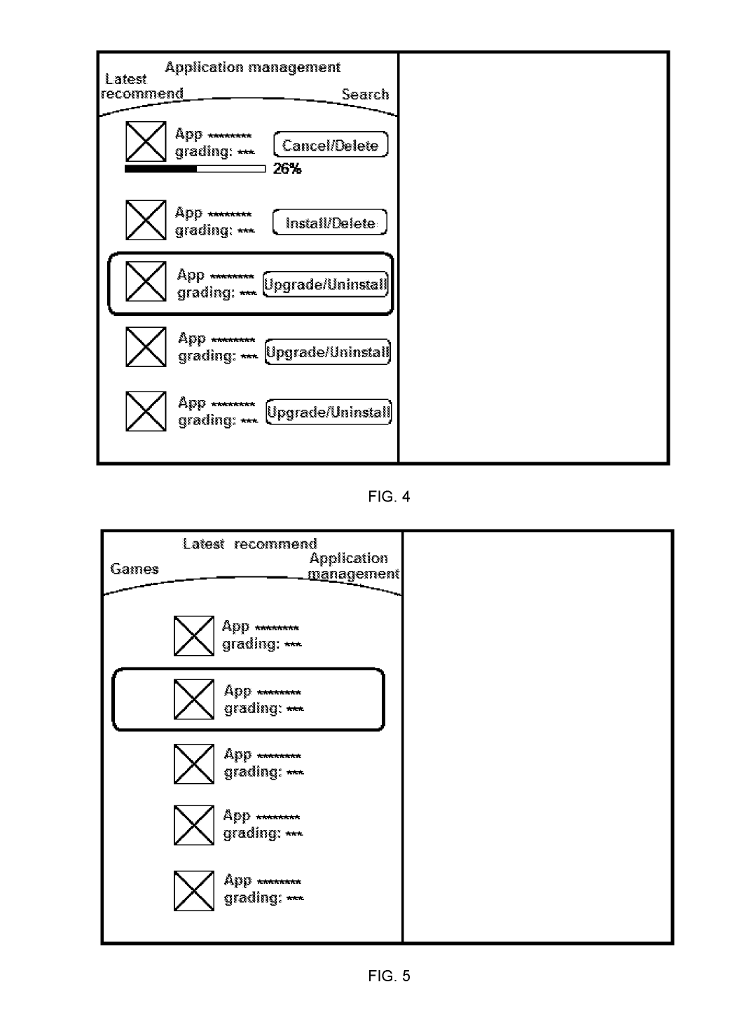

In the present embodiment, the display window contains a category label, and a view corresponding to the present category label. For example, referencing to FIG. 4, category labels may include “Application management”, “Latest recommend”, “Search”, and more, of course, it is not necessary to display all category labels, for example, similar to FIG. 4, only the current category label together with the one on the left and the one on the right, are displayed, while other labels are hidden, and will show up only when labels are switched and pointed to. There is at least one item in each view, and when a display window is open, the focus locates on one item in the current view.

In the present embodiment, when opening a display window according to the starting instruction, a preset default category label is set as the current category label, and the default category label is the “Application management” label, and items contained in the according view include, a downloading application, and/or a downloaded application, and/or an installed application. In such a way, when a user enters an application product platform, he can manage his applications conveniently. Of course, in other embodiments, it is also possible to set a saved category label as the current category label, the saved category label was the saved last category label when exiting the application product platform last time. For example, when the user exit the application product platform last time, the last category label opened was “Games”, then, after acquiring the exit instruction (such as signals corresponding to the “Exit” key in the remote control device), the last category label was saved in the storage unit as the current label, and when the user launches the application product platform again, it will decide if there is a current category label saved, if it found the saved current category label is “Games”, then views corresponding to the label are displayed directly, and if there were no saved category labels, due to some reasons including a first time start, a system resetting or upgrading, a data clearing or else, then it is possible to select a default category label as the current category label, which may be set by the system, or set by the user. In the present embodiment, the “Application management” label is integrated into the application product platform as one of the category labels, and that makes a user need not exit the application product platform, before checking and managing his applications, for example, checking the current downloading applications, and their downloading progresses, removing or upgrading the installed applications, or else. However, in the current systems, if a user needs to check the current application downloading status, he needs to exit the application store, return to the desktop, before entering the application manager to check the downloading status.

In the present embodiment, the display window occupies only part of the display screen, which makes the effects to viewers watching TV minimum, for example, a user may bring the application product platform out for browsing, during the gap of broadcasting advertisements, and when a wonderful program starts, the user may also notice it at the first time, thus will not miss the favorite program. Of course, in other embodiments, a display window may also be a full screen window. In both cases of full-screen and part-screen, the display window may be displayed in a translucent way, so the user may pay attention to the TV programs. And, when displaying in a 2D way, the display windows may overlap each other and display over the picture of the TV program; and when displaying in a 3D way, the display window may be suspended in front of the picture of the TV program.

In the present embodiment, after acquiring the starting instruction, it further contains the following steps:

2011. connect to a background server, and pre-load information of items needed to display in various views.

In order to make the user's browsing smoother, the present embodiment employs asynchronous loading operations to acquire the items information needed to be displayed in the views corresponding to each category label. In a traditional applications store, since labels need to acquire focus before switching in between, therefore, only after the user moves the focus onto one label, will items information in the view corresponding to the label be loaded synchronously. For example, if a user wants to check the applications in the last category, category A, he must move the focus from the label for the first category to the label for category A, and during this process, whenever the focus is moved to any category label, the applications in the category will start to be loaded, and the user has to wait until the loading is finished, before being able to move the focus to the next category. If the network is not smooth enough, a lot of user's waiting time will be wasted. While in the present embodiment, the loading operations are executed asynchronously, labels corresponding to items in different categories are cached, and the data pre-loading and caching makes it not necessary to request data from background so frequently, thus the response speed will be greatly improved, therefore, even in the circumstances of poor network speeds, it may also ensure the users browsing smoothly.

After the display window is open, a user may browse the current view or switch to other category views, based on the user's instructions, the steps include:

202. acquire an item-switching instruction, and move the focus to the next item from the current item.

In the present embodiment, the item-switching instruction is corresponding to signals from the first set of input mechanism in the remote control device, the first set of input mechanism, for example, may be the up and down arrow keys in the remote control device. Since the focus is locating on one item in the view from the beginning, therefore, according to the item-switching instructions, the focus may be moved to the next item from the current item directly. In order to make the user's operation synchronize to the display in the view, it is possible to arrange the windows in a way that, the labels are locating on the top, and the corresponding views are displaying their contained items in a way of longitudinal list. For example, referencing to FIG. 5, under the label of “Latest recommend”, all applications are listed in a longitudinal way, and the user may move the focus onto the desired application item with the up and down arrow keys in the remote control device.

In other embodiments, the first set of input mechanism may also use the left arrow key and the right arrow key, accordingly, it may adjust the windows arrangement into a way that, the labels locate on the left, and the corresponding views are displaying their contained items in a way of transverse list.

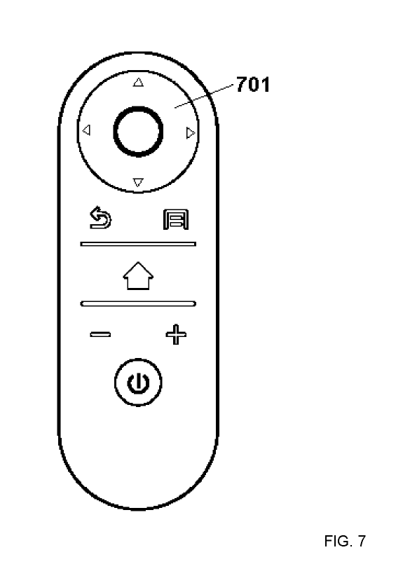

In some embodiments, the first set of input mechanism may also include a rotation panel in the remote control device, referencing to FIG. 7, a user may turn the rotation panel 701 with fingers, so the focus may move faster and smoother. In one implementation, the rotation panel together with the up and down arrow keys or together with the left and right arrow keys (for example, a touching point may locate below the rotation panel) may act as the first set of input mechanism, while in the other s, it may also adopt the rotation panel solely as the first set of input mechanism.

203. acquire a category-switching instruction, and switch the current view into the next view.

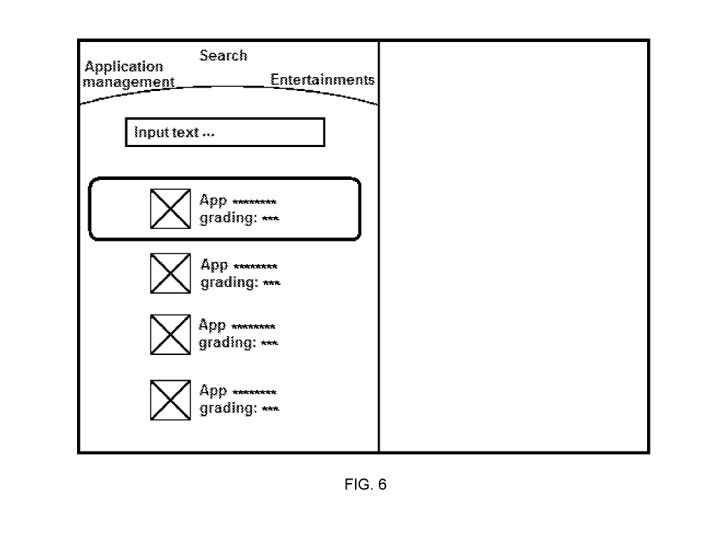

In the present embodiment, a category-switching instruction is corresponding to the signals from the second set of input mechanism in the remote control devices. The second set of input mechanism, for example, may be the left arrow key and the right arrow key in the remote control device, as long as the second set of input mechanism is totally different to the first set of input mechanism, and according to the category-switching instructions, it may switch the current view into the next view, while the focus locates on one item in the newly switched view. For example, referencing to FIG. 6, if the application product platform starts and displays the view of “Application management”, the user may press the right arrow key to switch to the view of “Searching”, and after the views switching, the focus locates on one item in the switched view again.

In other embodiments, if the first set of input mechanism are the left arrow key and the right arrow key in the remote control device, then the second set of input mechanism may also choose the up arrow key and the down arrow key in the remote control device, as long as the second set of input mechanism are totally different to the first set of input mechanism. Such an arrangement brings no cross or disturbing between browsing applications and switching pages, which makes the operating process smoother. Also, during the entire operations, no focuses will locate on any labels; instead, focuses will always be on one item in the view. So it saves the user's operation steps during cross-categories browsing.

In some embodiments, the second set of input mechanism may also include the rotation panel in the remote control device, such as the rotation panel 701 in FIG. 7, a user may turn the rotation panel 701 with fingers, so switching between different category views may be faster. In one , the rotation panel together with the up and down arrow keys or together with the left and right arrow keys, may act as the second set of input mechanism, while in other s, it may also adopt the rotation panel solely as the second set of input mechanism.

In the present embodiment, for a more user-friendly browsing operation, each view may memorize the users current operations, that is, after acquiring a category-switching instruction, it further includes the following steps:

2031. save the focus location in the current view.

Wherein, the focus location may include the position information of the focus, and/or the mark information of the item carrying the focus.

2032. locate the item to carry the focus, when switching to the next view, based on the saved focus position in the specific view. In details, that is, decide if there are any saved focus positions corresponding to the switched view, if there are, then locate the item to carry the focus based on the saved focus position; if there are not, then locate the item to carry the focus according to a preset rule.

In such a way, users' operations in different categories may be continuous, for example, a user is browsing applications in the category of “Games”, and he has reached the 23th application, then, he needs to switch to the category of “Application management”, after a serious of operations, he returns to the category of “Games”, and the focus is still locating on the same position when he left last time, he does not need to browse from the first application. Of course, if, it is the first time access, or the system resets, upgrades, or data clearance happened, and causes no saved focus positions, then, the focus position could be set according to a preset rule, for example, arrange the focus on the first item. In other s, it may also not memorize the user's operations in a view, instead, locating the focus on an item according to the preset rule, each time, when entering the view.

In the present embodiment, the non-cross control method between applications browsing and views switching is also applicable to the items displaying process in the window after entering the applications. In details, it includes the following steps:

204. acquire an item entering instruction, and open an item window.

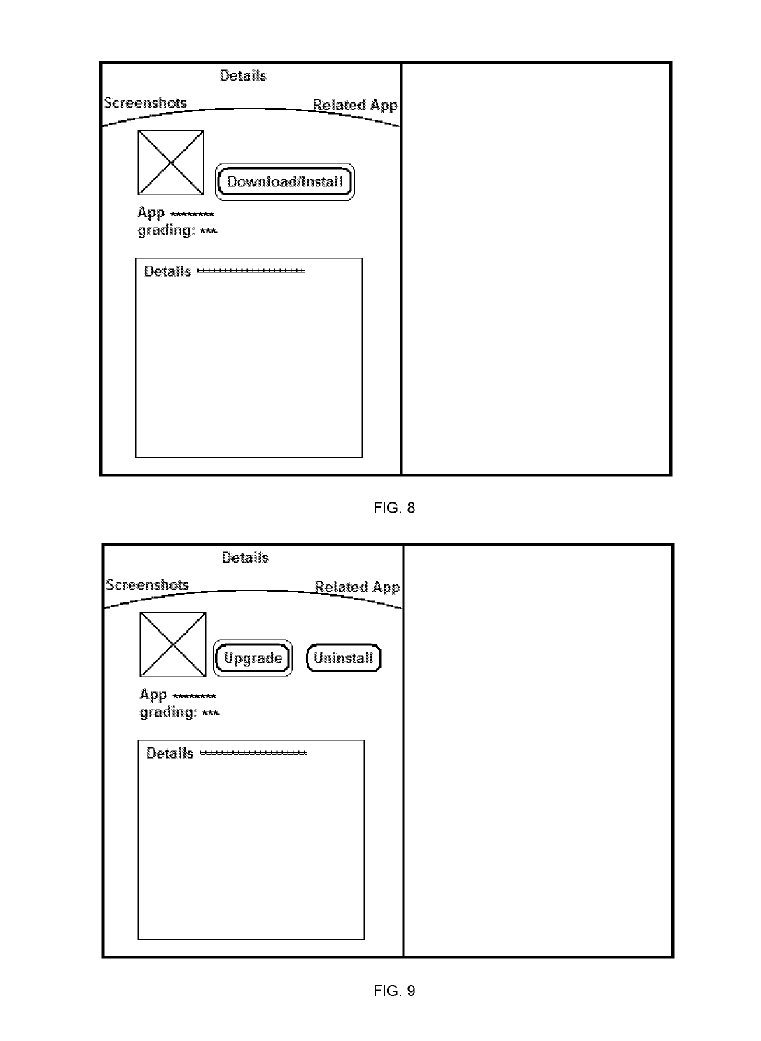

It may adopt a conventional method to enter an application, for example, adopting the signals corresponding to an “OK” key in the remote control device as the item entering instruction, and opening an item window corresponding to the item carrying the focus. The item window may substitute or overlap the above mentioned display window. There is no limitation on it in the present embodiment. The item window may adopt a similar structure as the display window, that is, it includes a sub-category label and a sub-view corresponding to the sub-category labels, and at least one sub-item in the sub-view, while the focus is locating on a sub-item in the sub-view. For example, referencing to FIGS. 8 and 9, the sub-category labels include “Details”, “Screenshots”, “Related applications”, etc., when opening an item window, it may enter the “Details” sub-view by default, and the focus is locating on one sub-item corresponding to the executable operations, for example, for a not yet downloaded application, the sub-item could be “Download and install”, while for an installed application, the sub-item could be “Upgrade” and “Uninstall” (while the focus locates on one of them, such as “Upgrade”). Similar to the cases of display windows, after an item window is open, it may browse the current sub-view or switch to other sub-views in other sub-categories, according to the user's instructions, and the steps include:

205. acquire a sub-item-switching instruction, and move the focus to the next sub-item from the current sub-item.

In the present embodiment, the sub-item-switching instruction is corresponding to the signals from the first set of input mechanism, and the focus is moved to the next sub-item from the current sub-item, according to the sub-item-switching instructions. Since the number of sub-items in the item window is relatively rare, in other s, the sub-item-switching may also adopt other methods flexibly, such as arranging special keys for switching purposes based on the positions relationship between sub-items, and in order to make the user's operations more intuitive.

206. acquire a sub-category-switching instruction, and switch the current sub-view into the next sub-view.

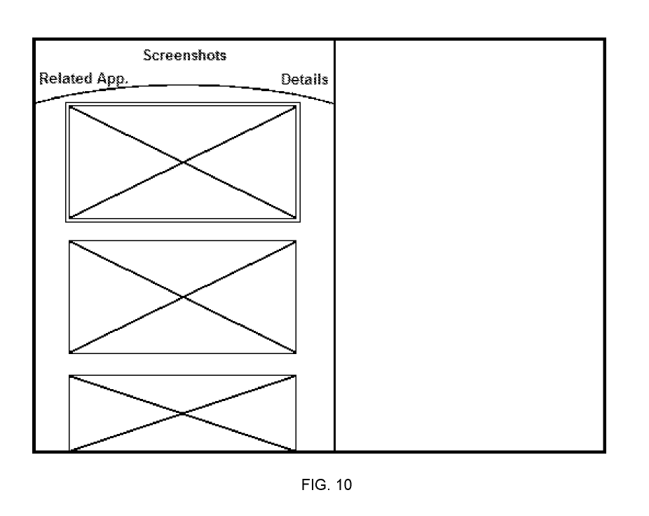

In the present embodiment, the sub-category-switching instruction is corresponding to the signals from the second set of input mechanism, and switching the current sub-view to the next sub-view, according to the sub-category-switching instruction, while the focus locates on a sub-item in the switched sub-view, for example, referencing to FIG. 10, when entering the item window, if the displayed sub-view in the window was initially the sub-view of “Details”, then the user may switch the sub-view into that of “Screenshots” through pressing the left arrow key in the remote control device, after the sub-view switching, the focus again locates on one item in the switched sub-view, such as locating on the first screenshot picture.

Similar to the cases of display windows, a sub-view may also memorize a user's current operations, and here, it will not be repeated in details again.

In order to further facilitate a user's operations, after entering some sub-items, it may jump directly to the related views in the display window from the item window, for example, it includes the following steps:

207. acquire a sub-item entering instruction, if the sub-item carrying the current focus is applications “Download/Install”, then jump to a display window, and the current category label is “Application management”, the items in the according views include: the applications downloading, and/or the applications downloaded, and/or the applications installed, while the focus is locating on the item corresponding to the instruction for starting the jump. In such a way, after the user enters the “Download/install”sub-item from the items window (for example, take the signals from the “OK” key in the remote control device as the sub-item entering instruction), the system will jump to the “Application management” page in the display window automatically, and display the downloading progress of the downloading applications in the “Application management” page. For applications in downloading, the user may execute “Pause” or “Delete” operations conveniently. When the applications downloading are finished, the system will automatically execute the installation operations for those downloaded applications, without any manual operations from the users. And, if, during the downloading processes, due to poor network conditions or other reasons, the downloads fail, the users may also execute the “Resume downloading” operations in the application management interface conveniently.

When the intelligent terminal equipment as described in the present invention is displaying the interfaces for application product platform, labels will acquire no focuses, which has greatly saved the required operation steps during the cross-categories browsing, and has made the user's operations smoother, thus, it has matched the user's usage habits better.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

1. An interface display method of application product platform, wherein, it includes the following steps:
acquire a starting instruction for the application product platform, open a display window on a display screen according to the starting instruction, the display window includes a category label and a corresponding view corresponding to the current category label, and there is at least one item listed in the view, and a focus locates on one item in the view;
acquire an item-switching instruction, the item-switching instruction is corresponding to a signal from a first set of input mechanism in a remote control device, and moving the focus to a next item from a current item, based on the item-switching instruction;
acquire a category-switching instruction, the category-switching instruction is corresponding to a signal from a second set of input mechanism in the remote control device, and switching the current view to the next one, while locating the focus onto one item in the new view, based on the category-switching instruction, and the second set of input mechanism are totally different to the first set of input mechanism.

2. The interface display method of application product platform according to claim 1, wherein, after acquiring the category-switching instruction, it further includes:
save the focus location in the current view, the focus location includes the position information of the focus, and/or the mark information of the item carrying the focus;
decide whether there are any saved focus positions corresponding to the switched view, when switching to the next view, if there are, then locate the item to carry the focus based on the saved focus position; if there are not, then locate the item to carry the focus according to a preset rule.

3. The interface display method of application product platform according to claim 1, wherein, the first set of input mechanism are the up and down arrow keys in the remote control device, the second set of input mechanism are the left and right arrow keys in the remote control device; or, the first set of input mechanism are the left and right arrow keys in the remote control device, the second set of input mechanism are the up and down arrow keys in the remote control device.

4. The interface display method of application product platform according to claim 1, wherein, the first set of input mechanism include a rotation panel in the remote control device, or, the second set of input mechanism include the rotation panel in the remote control device.

5. The interface display method of application product platform according to claim 1, wherein, after acquiring the starting instruction, it further includes: connecting to a background server, and pre-loading information of items needed to display in views corresponding to various category labels.

6. The interface display method of application product platform according to claim 1, wherein, when opening a display window according to the starting instruction, a preset default category label is set as the current category label, or, a saved category label is set as the current category label, the saved category label was the saved last category label when exiting the application product platform last time.

7. The interface display method of application product platform according to claim 6, wherein, when opening a display window according to the starting instruction, a preset default category label is set as the current category label, and the default category label is the “Application management” label, and items contained in the corresponding view include, a downloading application, and/or a downloaded application, and/or an installed application.

8. The interface display method of application product platform according to claim 1, wherein, it further includes:
acquire an item entering instruction, and open an item window in the display screen, corresponding to the item carrying the current focus, the item window substitutes or overlaps the display window, the item window includes a sub-category labels and a sub-views corresponding to the sub-category labels, and at least one sub-item in the sub-view, while the focus is locating on a sub-item in the sub-view;
acquire a sub-item-switching instruction, the sub-item-switching instruction is corresponding to the signals from the first set of input mechanism, and the focus is moved to the next sub-item from the current sub-item, according to the sub-item-switching instructions;
acquire a sub-category-switching instruction, the sub-category-switching instruction is corresponding to the signals from the second set of input mechanism, and switch the current sub-view into the next sub-view, according to the sub-category-switching instruction, while the focus locates on a sub-item in the switched sub-view.

9. The interface display method of application product platform according to claim 8, wherein, it further includes:
acquire a sub-item entering instruction, if the sub-item carrying the current focus is applications downloading, then jump to the display window, and the current category label is “Application management”, the items in the according views include: the applications downloading, and/or the applications downloaded, and/or the applications installed, while the focus is locating on the item corresponding to the instruction for starting the jump.

10. The interface display method of application product platform according to claim 1, wherein, the display window is a window occupying part of the display screen, or a full screen window, the display window is displayed in a translucent way.

11. An intelligent terminal equipment, wherein, it includes:
a display unit, applied to control a screen display;
a remote control signals receiving unit, applied to receive a signal from a remote control device;
a storage unit, applied to store data, including a program capable of being executed by a processor;
a processor, data connecting to the display unit, the remote control signals receiving unit and the storage unit, applied to execute a program, the program for executing includes the one achieving an interface display method of application product platform according to the following steps:
acquire a starting instruction for the application product platform, open a display window on a display screen according to the starting instruction, the display window includes a category label and a corresponding view according to the current category label, and there is at least one item listed in the view, and a focus locates on one item in the view;
acquire an item-switching instruction, the item-switching instruction is according to a signal from a first set of input mechanism in a remote control device, and moving the focus to a next item from a current item, based on the item-switching instruction;
acquire a category-switching instruction, the category-switching instruction is according to a signal from a second set of input mechanism in the remote control device, and switching the current view to the next one, while locating the focus onto one item in the new view, based on the category-switching instruction, and the second set of input mechanism are totally different to the first set of input mechanism.

12. The intelligent terminal equipment according to claim 11, wherein, the intelligent terminal equipment is a TV set.

13. The intelligent terminal equipment according to claim 11, wherein, after acquiring the category-switching instruction, it further includes:
save the focus location in the current view, the focus location includes the position information of the focus, and/or the mark information of the item carrying the focus;
decide if there are any saved focus positions according to the switched view, when switching to the next view, if there are, then locate the item to carry the focus based on the saved focus position; if there are not, then locate the item to carry the focus according to a preset rule.

14. The intelligent terminal equipment according to claim 11, wherein, when opening a display window according to the starting instruction, a preset default category label is set as the current category label, or, a saved category label is set as the current category label, the saved category label was the saved last category label when exiting the application product platform last time.

15. The intelligent terminal equipment according to claim 11, wherein, when opening a display window according to the starting instruction, a preset default category label is set as the current category label, and the default category label is the “Application management” label, and items contained in the corresponding view include: a downloading application, and/or a downloaded application, and/or an installed application.

16. The intelligent terminal equipment according to claim 11, wherein, it includes:
acquire an item entering instruction, and open an item window in the display screen, corresponding to the item carrying the current focus, the item window substitutes or overlaps the display window, the item window includes a sub-category labels and a sub-views corresponding to the sub-category labels, and at least one sub-item in the sub-view, while the focus is locating on a sub-item in the sub-view;
acquire a sub-item-switching instruction, the sub-item-switching instruction is corresponding to the signals from the first set of input mechanism, and the focus is moved to the next sub-item from the current sub-item, according to the sub-item-switching instructions;
acquire a sub-category-switching instruction, the sub-category-switching instruction is corresponding to the signals from the second set of input mechanism, and switch the current sub-view into the next sub-view, according to the sub-category-switching instruction, while the focus locates on a sub-item in the switched sub-view.

17. The intelligent terminal equipment according to claim 11, wherein, it includes:
acquire a sub-item entering instruction, if the sub-item carrying the current focus is applications downloading, then jump to the display window, and the current category label is “Application management”, the items in the according views include: the applications downloading, and/or the applications downloaded, and/or the applications installed, while the focus is locating on the item corresponding to the instruction for starting the jump.
